(19) United States
(12) Patent Application Publication
(10) Pub. No.: US 2009/0062457 A1
(43) Pub. Date: Mar. 5, 2009

(54) STYRENIC BLOCK COPOLYMERS AND COMPOSITIONS CONTAINING THE SAME

(75) Inventors: Dale L. HANDLIN, JR., Houston, TX (US); Carl L. WILLIS, Houston, TX (US); Robert C. BENING, Katy, TX (US)

Correspondence Address: KRATON POLYMERS U.S. LLC, WESTHOLLOW TECHNOLOGY CENTER, 3333 HIGHWAY 6 SOUTH, HOUSTON, TX, 77082, US

(73) Assignee: KRATON POLYMERS U.S. LLC, Houston, TX (US)

(21) Appl. No.: 11/849,879

(22) Filed: Sep. 4, 2007

(51) Int. Cl. C08L 53/00; C08F 10/08

(52) U.S. Cl. 524/573; 525/95

(57) ABSTRACT

A block copolymer of the formula [S-I-(I/B)]ₙX or [S-I-(I/B)-/B]ₙX or mixtures thereof wherein each S is independently a polymer block of an alkenyl arene; each I is a polymer block of isoprene; each B is a polymer block of butadiene and each (I/B) is a mixed random polymer block of isoprene and butadiene in a weight ratio I:B of from about 10:90 to about 90:10, n is an integer equal to or greater than 2, X is the residue of a coupling agent, and wherein the alkenyl arene content of the block copolymer represents a weight ratio of the alkenyl arene block to conjugated diene block of the total block copolymer and is in the range of from about 15 to about 35 wt %. Compositions for the manufacture of transparent, gel-free films, adhesives, fibers, injection molded articles, dipped goods, oil gels, and bitumen are also disclosed and comprise from about 3 to about 90 wt % of the claimed block copolymer and one or more components selected from thermoplastic resins, polyolefins, tackifying resins, end block resins, polystyrene, oils, engineering thermoplastics, fillers, and antioxidants.

### FIELD OF THE INVENTION

The present invention relates to styrenic block copolymers which have at least one polymer block of alkenyl arene, at least one polymer block of isoprene and at least one polymer block obtained by the random copolymerization of isoprene and butadiene. The present invention further relates to the use of these styrenic block copolymers in compositions for the manufacture of transparent, gel-free films, adhesives, fibers, injection molded articles, dipped goods, and oil gels.

### BACKGROUND OF THE INVENTION

The preparation of block copolymers is well known. In a representative synthetic method, an initiator compound is used to start the polymerization of one monomer. The reaction is allowed to proceed until all of the monomer is consumed, resulting in a living homopolymer. To this living homopolymer is added a second monomer that is chemically different from the first. The living end of the first polymer serves as the site for continued polymerization, thereby incorporating the second monomer as a distinct block into the linear polymer. The block copolymer so grown is living until terminated.

Termination converts the living end of the block copolymer into a non-propagating species, thereby rendering the polymer non-reactive toward monomer or coupling agent. A polymer so terminated is commonly referred to as a diblock copolymer. If the polymer is not terminated the living block copolymers can be reacted with additional monomer to form a sequential linear block copolymer. Alternatively the living block copolymer can be contacted with multifunctional agents commonly referred to as coupling agents. Coupling two of the living ends together results in a linear triblock copolymer having twice the molecular weight of the starting, living, diblock copolymer. Coupling more than two of the living diblock copolymer regions results in a radial block copolymer architecture having at least three arms.

One of the first patents on linear ABA block copolymers made with styrene and butadiene is U.S. Pat. No. 3,149,182. Since then a large number of patents have issued relating to block copolymers of styrene, butadiene and isoprene. Representative examples of such patents include U.S. Pat. No. 5,246,987; U.S. Pat. No. 5,292,819; U.S. Pat. No. 5,399,627; U.S. Pat. No. 5,405,903; U.S. Pat. No. 5,532,319; U.S. Pat. No. 5,583,182; U.S. Pat. No. 5,948,594; U.S. Pat. No. 6,174,939; U.S. Pat. No. 6,777,493; U.S. Pat. No. 6,833,411; U.S. Pat. No. 6,964,996; U.S. Pat. No. 6,987,145; EP 1,426,411 A1; Ep 1,473,595 A1; WO 2002057386; CN 1153183; CN 1244541; DE 2942128; JP 52019190; JP 49025038; J 48076940; and JP 45025310.

Elastomeric compositions which can be easily extruded into elastic films having low stress relaxation, low hysteresis or permanent set, and high recoverable energy are known from e.g. U.S. Pat. Nos. 4,663,220; 4,789,699; 4,970,259; 5,093,422; 5,705,556. Processes for making such cast extruded films and extrusion blown films have to meet high requirements as to the viscosity of the composition. At the same time, applications of these extrudates in personal hygiene are related to stringent requirements on mechanical behavior, i.e. combination of high strength and excellent elasticity (good stress relaxation and low hysteresis and permanent set) is needed. One of the greatest challenges in this field is still to find a good balance between flow/viscosity and the mechanical properties mentioned above. Films based on either Styrene-Butadiene-Styrene (SBS) or Styrene-Isoprene-Styrene (SIS) block copolymers can achieve the strength and elasticity required for personal hygiene articles. However, during film formation by extrusion casting or blowing SBS polymers tend to crosslink. This leads to gel particles, also called fines or fisheyes, in the films and increased viscosity. SIS polymers, on the other hand tend to degrade by chain scission during processing. This results in loss of elastic properties and reduced viscosity as processing time increase which makes formation of films with consistent properties difficult. Blends of SBS and SIS polymers can be made into films with a more stable viscosity during processing, but this does not solve the problem of gel particles since the SBS still crosslinks and the SIS chain scissions. Random mixtures of isoprene and butadiene monomer can be used in the elastomer block to make an S-I/B-S, but these polymers have low strength and elasticity.

It is an object of the present invention to provide compositions which have an improved balance of properties in personal hygiene applications and more in particular have an improved balance of properties of compositions for mono- or multi-layer films, i.e. compositions showing improved melt stability, providing elastic, transparent films without fines/fish eyes/gels, in combination with good tensile strength and low permanent set.

### SUMMARY OF THE INVENTION

The present application relates to a block copolymer of the formula:

[S-I-(I/B)]ₙX or [S-I-(I/B)-B]ₙX or mixtures thereof

wherein each S is independently a polymer block of an alkenyl arene having a molecular weight of 8,000 to 25,000,
each I is a polymer block of isoprene having a molecular weight of 5,000 to 10,000,
each (I/B) is a mixed random polymer block of isoprene and butadiene in a weight ratio of isoprene to butadiene of from about 10:90 to about 90:10,
n is an integer equal to or greater than 2,
each B is a polymer block of butadiene having a molecular weight of 1,000 to 50,000,
X is the residue of a coupling agent, where the block copolymer has a coupling efficiency of greater than 90 weight percent, and
wherein the alkenyl arene content of the block copolymer represents a weight ratio of the alkenyl arene block to conjugated diene block of the total block copolymer and is in the range of from about 10 to about 35 wt %.

The block copolymer of the present invention has a coupling efficiency (“CE”) greater than 90% by weight, preferably greater than 93% by weight. The resulting polymer with the high coupling efficiency has desirable thermal stability and mechanical properties, especially in personal hygiene products. Further, as shown in the examples, the enriched isoprene region next to the styrene block is important because it allows high strength which is not present in random I/B rubber blocks. It is also important that the block copolymer be a coupled polymer as opposed to a sequential polymer, since coupled polymers allow the greatest control over the molecular weight of each block in a multiblock polymer. As shown below in the examples, the block copolymers of the present invention have improved tensile strength and process stability because, despite the fact that they contain butadiene, they show much less crosslinking than typical SBS polymers and much less chain scission than SIS polymers.

The present invention further relates to a block copolymer composition that comprises:
(a) from about 30 to about 90 wt % of the block copolymer as defined hereinbefore; and
(b) one or more components selected from components selected from olefin polymers, styrene polymers, styrene/diene block copolymers, hydrogenated styrene/diene block copolymers, tackifying resins, end block resins, oils, engineering thermoplastics, fillers, colorants, and antioxidants,
wherein the sum of the percentages of the components (a) and (b) is 100%, and all weight percentages are relative to the weight of the complete composition.

Furthermore, the present invention relates to the use of said block copolymer compositions for the manufacture of transparent, gel-free films, adhesives, fibers, injection molded articles and oil gels.

It will be appreciated that another aspect of the invention is formed by extruded mono- or multi-layer films, more particularly, cast or blown mono- or multi-layer films for personal hygiene applications from the hereinbefore specified compositions. Accordingly, it is significant that the polymers of the present invention have a preferred balance of properties that make them exceptionally well suited for such applications. These properties include a melt flow of 1 to about 40 g/10 minutes as measured at 200° C. under a load of 5 kg in accordance with ASTM D1238-95; tensile strength of at least about 2700 psi as measured according to ASTM D412, and thermal stability of less than about 100% increase in viscosity after one hour at 230° C.

### DETAILED DESCRIPTION OF THE INVENTION

The block copolymers of the present invention are of the formula:

[S-I-(I/B)]ₙX or [S-I-(I/B)-B]ₙX or mixtures thereof

wherein each S is independently a polymer block of alkenyl arene, each I is independently a polymer block of isoprene; each (I/B) is independently a mixed random polymer block of isoprene and butadiene in a weight ratio I:B of from about 10:90 to about 90:10, and each B is a polymer block of butadiene.
Each S is independently a polymer block of an alkenyl arene selected from styrene, alpha-methylstyrene, para-methylstyrene, o-methylstyrene, p-tert-butylstyrene, 2,4-dimethylstyrene, diphenylethylenes including stilbene, vinyl naphthalene, vinyltoluene (a mixture of meta- and para-isomers of methylstyrene), vinylxylene and mixtures thereof. Of these, styrene is the most preferred and is commercially available, and relatively inexpensive, from a variety of manufacturers.
The S blocks of the present block copolymer each individually have an apparent molecular weight from about 8,000 to about 25,000, more preferably from about 10,000 to about 18,000.

As used herein with regard to the present invention, the term “molecular weights” refers to the molecular weight in g/mol of the polymer or block of the copolymer. The molecular weights referred to in this specification and claims can be measured with gel permeation chromatography (GPC) using polystyrene calibration standards, such as is done according to ASTM 3536. GPC is a well-known method wherein polymers are separated according to molecular size, the largest molecule eluting first. The chromatograph is calibrated using commercially available polystyrene molecular weight standards. The molecular weight of polymers measured using GPC so calibrated are styrene equivalent molecular weights. The styrene equivalent molecular weight may be converted to true molecular weight when the styrene content of the polymer and the vinyl content of the diene segments are known. The detector used is preferably a combination ultraviolet and refractive index detector. The molecular weights expressed herein are measured at the peak of the GPC trace, converted to true molecular weights, and are commonly referred to as “peak molecular weights”.

In the block copolymers, the S blocks represent an alkenyl arene content which is the weight ratio of the alkenyl arene block to conjugated diene block of the total block copolymer that is from about 10 to about 35 wt %. Preferably the alkenyl arene content will be from about 15 to about 32 wt %.

Each I block is independently an isoprene block. One important aspect of the present invention is the purity of the isoprene utilized for the isoprene blocks. While the preferred isoprene blocks will be 100% pure isoprene, those skilled in the art will recognize that in certain instances minor amounts of other comonomers may be present as a byproduct of production of the isoprene. These small proportions of other comonomers in the isoprene blocks can consist of structurally related styrenes and/or alkadienes. When such other comonomers are present, they should not be present in amounts that exceed 10 wt % of the total amount of the particular I block. Further, according to one way to make polymers of the present invention wherein isoprene monomer is added at a much higher rate than butadiene monomer, the isoprene preferentially polymerizes first, forming a block comprising primarily isoprene (e.g. greater than 90 wt % isoprene) before significant amounts of butadiene monomer are polymerized.

The apparent molecular weight of the I blocks is independently from about 5,000 to about 10,000, preferably from about 6,000 to about 8,000.

The apparent molecular weight of the B blocks is independently from about 1,000 to about 50,000, preferably from about 1,000 to about 15,000. The amount of the butadiene in the B blocks preferably comprises between 20 and 50 weight percent of the butadiene in the coupled block copolymer.

The block copolymers of the present invention have (I/B) blocks in which I is isoprene and B is butadiene, wherein the weight ratio of isoprene to butadiene is from about 10:90 to about 90:10, preferably about 30:70 to about 70:30, and wherein the isoprene/butadiene mixtures have been randomly copolymerized, i.e. without any substantial homopolymer blocks, lengths pB and pI of more than 30 monomer units. The I/B blocks have a molecular weight of about 25,000 to about 150,000, preferably about 30,000 to about 60,000. In the preferred embodiment, the mixed polymer block (I/B) does not contain other copolymerizable comonomers (will be composed of mixtures of pure isoprene and pure butadiene). However, those skilled in the art will recognize that in certain instances due to processing conditions, small amounts of other copolymerizable comonomers may be present. When this does occur, these other copolymerizable comonomers will typically be present in small amounts, less than 5 wt % of the particular block.

Polymers having the mixed midblocks derived from the random copolymerization of isoprene and butadiene, are defined as having average homopolymer block lengths of less than 30 monomer units, preferably less than 25 monomer units, and more preferably less than 20 monomer units. Average homopolymer block length is determined by the method, based carbon-13 NMR, as described in detail in WO 02/057386, from page 12, line 14 to page 15, line 13, which is incorporated herein by reference.

Each n in the above formulas is independently an integer equal to or greater than 2. In most instances, n will be an integer from about 2 to about 30. In many applications, n is an integer from 2 to 6, preferably from 2 to 4, more preferably 2 or 3. Each X is the residue of a coupling agent to be specified hereinafter.

The overall apparent molecular weight of the block copolymers of the present invention will range from about 40,000 to about 400,000, typically from about 70,000 to about 150,000 with the desired range of molecular weights depending upon the specific formula of the block copolymer.

The block copolymers preferably contain 1,2-vinyl bonds and/or 3,4-vinyl bonds in a proportion of at most 15 wt %, based on the weight of the conjugated diene. While the preferred invention is where the I, B and I/B components contain 1,2-vinyl bonds and/or 3,4-bonds in proportion of at most 15 wt %, those of ordinary skill in the art will recognize that 1,2-vinyl bonds and/or 3,4-vinyl bonds in a proportion of greater than 15 wt % may also be possible.

The block copolymers used in the present invention have a Coupling Efficiency (“CE”) of about 90 to 100 weight percent, preferably above 93 weight percent, more preferably above about 95 weight percent. Coupling Efficiency is defined as the proportion of polymer chain ends which were living, P-Li, at the time the coupling agent was added that are linked via the residue of the coupling agent at the completion of the coupling reaction. In practice, Gel Permeation Chromatography (GPC) data is used to calculate the coupling efficiency for a polymer product.

The block copolymers of the present invention will be made by a coupling reaction as opposed to a strict sequential polymerization. Block copolymers according to the present invention can be made by coupling of an initially prepared living diblock copolymer, obtained by sequential polymerization of predetermined batches of alkenyl arene, followed by isoprene, and then mixture of isoprene/butadiene by anionic polymerization in an inert organic solvent with a coupling agent (to provide a copolymers with two blocks (arms), three blocks (arms) or multiblocks (more than three arms). The remaining living block copolymers have to be terminated by addition of a proton donating agent, such as an alkanol, e.g. ethanol or water.

The coupling agent, when used, can include, but is not limited to, tin coupling agents such as tin dichloride, monomethyltin dichloride, dimethyltin dichloride, monoethyltin dichloride, diethyltin dichloride, methyltin trichloride, monobutyltin dichloride, dibutyltin dibromide, monohexyltin dichloride and tin tetrachloride; halogenated silicon coupling agents such as dichlorosilane, monomethyldichlorosilane, dimethyldichlorosilane, diethyldichlorosilane, monobutyldichlorosilane, dibutyldichlorosilane, monohexyldichlorosilane, dihexyldichlorosilane, dibromosilane, monomethyldibromosilane, dimethyldibromosilane, silicon tetrachloride and silicon tetrabromide; alkoxysilanes such as tetramethoxysilane, tetraethoxysilane, and methyltrimethoxy silane; and tetramethoxysilane; divinyl aromatic compounds such as divinylbenzene en divinyl naphthalene; halogenated alkanes such as dichloroethane, dibromoethane, methylene chloride dibromomethane, dichloropropane, dibromopropane, chloroform, trichloroethane, trichloropropane and tribromopropane; halogenated aromatic compounds such as dibromobenzene; epoxy compounds such as the diglycidyl ether of bisphenol-A (e.g. EPON™ 825 or EPON™ 826) and the like, and other coupling agents such as benzoic esters, CO₂, 2 chloroprene and 1 chloro-1,3-butadiene and diethyl adipate or dimethyl adipate. Of these tri- and tetra(alkoxy)silanes are preferred. The resulting block copolymer may be linear (where n is 2), or radial (where n is 3 or more), or a mixture of linear and radial polymers.

Thus each coupled block copolymer may contain a complimentary diblock [S-I-(I/B)] or [S-I-(I/B)-B] where the ratio of coupled block copolymer component to its complimentary diblock may range in weight ratio of from 100:0 to 90:10, preferably 100:0 to 93:7, more preferably from about 100:0 to about 95:5.

In general, the polymers useful in this invention may be prepared by contacting the monomer or monomers with an organoalkali metal compound in a suitable solvent at a temperature within the range from −150° C. to 300° C., preferably at a temperature within the range from 0° C. to 100° C. Particularly effective polymerization initiators are organolithium compounds having the general formula

RLi

wherein R is an aliphatic, cycloaliphatic, alkyl-substituted cycloaliphatic, aromatic or alkyl-substituted aromatic hydrocarbon radical having from 1 to 20 carbon atoms of which sec.butyl is preferred.

Suitable solvents include those useful in the solution polymerization of the polymer and include aliphatic, cycloaliphatic, alkyl-substituted cycloaliphatic, aromatic and alkyl-substituted aromatic hydrocarbons, ethers and mixtures thereof. Suitable solvents, then, include aliphatic hydrocarbons such as butane, pentane, hexane and heptane, cycloaliphatic hydrocarbons such as cyclopentane, cyclohexane and cycloheptane, alkyl-substituted cycloaliphatic hydrocarbons such as methylcyclohexane and methylcycloheptane, aromatic hydrocarbons such as benzene and the alkyl-substituted hydrocarbons such as toluene and xylene, and ethers such as tetrahydrofuran, diethylether and di-n-butyl ether. Preferred solvents are cyclopentane or cyclohexane.

The block copolymers according can be made by adaptation of common processes used for the preparation of S-B-S type block copolymers and/or S-I-S type block copolymers, with the exception of including a block that comprises a mixture of butadiene/isoprene in addition to the I block. One means of making the polymer is to add only isoprene monomer after the styrene block, and then to add either butadiene or a mixture of isoprene and butadiene. Another means to the polymer is to add a mixture of isoprene and butadiene where the isoprene is added at a faster rate than the butadiene monomer. For example, each of isoprene and butadiene were added at rates of 3×kg/min and IX kg/min, respectively, until all the monomer is added. In that case, the isoprene preferentially polymerizes first, forming a block comprising primarily isoprene (e.g. greater than 90 wt % isoprene) before significant amounts of butadiene monomer are polymerized. Of importance in the preparation of the block copolymers according to the present invention is to avoid homopolymer block formation when adding the (I/B) block, in order to ensure the appropriate I/B ratio, and to produce a polymer block wherein the (I/B) random block has a Tg of −60° C. or less. This generally rules out the use of randomizers, as for instance used by Kuraray in the production of hydrogenated styrene isoprene/butadiene block copolymers (reference is made to U.S. Pat. No. 5,618,882 which is incorporated herein). It is preferred that the polymer also have a butadiene block B after the (I/B) block and prior to coupling.

### Block Copolymer Composition

The present invention further relates to compositions that comprise:
(a) from about 30 to about 90 wt % of at least one block copolymer of the formula

[S-I-(I/B)]ₙX or [S-I-(I/B)-B]ₙX or mixtures thereof
wherein S, I, (I/B), B, n and X are as defined hereinbefore; and
(b) at least on one of the components selected from olefin polymers, styrene polymers, styrene/diene block copolymers, hydrogenated styrene/diene block copolymers, tackifying resins, end block resins, oils, engineering thermoplastics, fillers, and antioxidants.

Component (a)
The specific block copolymer utilized and the amount utilized in the composition will depend upon the specific end use for the block copolymer. For example, in the case of transparent, gel-free films, coupled polymers are preferred in an amount from about 60 to about 90 wt %.

Component (b)
The block copolymers of the present invention may be blended with any number of other components to form the compositions of the present invention. Such compositions of the present invention will comprise at least on one of the components selected from olefin polymers, styrene polymers, styrene/diene block copolymers, hydrogenated styrene/diene block copolymers, tackifying resins, end block resins, oils, fillers, colorants, and antioxidants, as well as other known additives.

Olefin polymers include, for example, ethylene homopolymers, ethylene/alpha-olefin copolymers, propylene homopolymers, propylene/alpha-olefin copolymers, high impact polypropylene, butylene homopolymers, butylene/alpha olefin copolymers, and other alpha olefin copolymers or interpolymers. Representative polyolefins include, for example, but are not limited to, substantially linear ethylene polymers, homogeneously branched linear ethylene polymers, heterogeneously branched linear ethylene polymers, including linear low density polyethylene (LLDPE), ultra or very low density polyethylene (ULDPE or VLDPE), medium density polyethylene (MDPE), high density polyethylene (HDPE) and high pressure low density polyethylene (LDPE). Other polymers included hereunder are ethylene/acrylic acid (EEA) copolymers, ethylene/methacrylic acid (EMAA) ionomers, ethylene/vinyl acetate (EVA) copolymers, ethylene/vinyl alcohol (EVOH) copolymers, ethylene/cyclic olefin copolymers, polypropylene homopolymers and copolymers, propylene/styrene copolymers, ethylene/propylene copolymers and polybutylene.

Styrene polymers include, for example, crystal polystyrene, high impact polystyrene, medium impact polystyrene, styrene/acrylonitrile copolymers, styrene/acrylonitrile/butadiene (ABS) polymers, syndiotactic polystyrene, styrene/methyl-methacrylate copolymers and styrene/olefin copolymers. Representative styrene/olefin copolymers are substantially random ethylene/styrene copolymers, preferably containing at least 10, more preferably equal to or greater than 25 weight percent copolymerized styrene monomer. Also included are styrene-grafted polypropylene polymers, such as those offered under the tradename Interloy® polymers, originally developed by Himont, Inc. (now Basell). Further, in many formulations it is preferable to add styrene diene block copolymers (e.g. S-I-S, S-B-S, S-I/B-S) and/or hydrogenated styrene diene block copolymers (e.g. S-EB-S, S-EP-S, S-EP, S-EB) and the like.

Tackifying resins include polystyrene block compatible resins and midblock compatible resins. The polystyrene block compatible resin may be selected from the group of coumarone-indene resin, polyindene resin, poly(methyl indene) resin, polystyrene resin, vinyltoluene-alphamethylstyrene resin, alphamethylstyrene resin and polyphenylene ether, in particular poly(2,6-dimethyl-1,4-phenylene ether). Such resins are e.g. sold under the trademarks “HERCURES”, “EN DEX”, “KRISTALEX”, “NEVCHEM” and “PICCOTEX”. Resins compatible with the (mid) block may be selected from the group consisting of compatible C₅ hydrocarbon resins, hydrogenated C₅ hydrocarbon resins, styrenated C₅ resins, C₅/C₉ resins, styrenated terpene resins, fully hydrogenated or partially hydrogenated Cg hydrocarbon resins, rosins esters, rosins derivatives and mixtures thereof. These resins are e.g. sold under the trademarks “REGALITE”, “REGALREZ”, “ESCOREZ” and “ARKON”.

The polymer blends of the present invention may be compounded further with other polymers, oils, fillers, reinforcements, antioxidants, stabilizers, fire retardants, antiblocking agents, lubricants and other rubber and plastic compounding ingredients without departing from the scope of this invention.

Examples of various fillers that can be employed are found in the 1971-1972 Modern Plastics Encyclopedia, pages 240-247. A reinforcement may be defined simply as the material that is added to a resinous matrix to improve the strength of the polymer. Most of these reinforcing materials are inorganic or organic products of high molecular weight. Various examples include glass fibers, asbestos, boron fibers, carbon and graphite fibers, whiskers, quartz and silica fibers, ceramic fibers, metal fibers, natural organic fibers, and synthetic organic fibers. Preferred are reinforced polymer blends of the instant invention containing 2 to 80 percent by weight glass fibers, based on the total weight of the resulting reinforced blend. Coupling agents, such as various silanes, may be employed in the preparation of the reinforced blends.

Table A below shows examples of various applications, with possible compositions and ranges for the individual components:

TABLE A
Applications, Compositions and Ranges

| | | Composition |
|---|---|---|
| Application | Ingredients | % w. |
| Films, Molding, Alloys | Polymer | 1-99% |
| | Ethylene copolymers: EVA, | 99-1% |
| | Ethylene/styrene | |
| Personal Hygiene Films and | Polymer | 40-95% |
| Fibers | PE | 0-30% |
| | PP | 0-30% |
| | Tackifying Resin | 5-30% |
| | End Block Resin | 5-20% |
| Personal Hygiene Films and | Polymer | 50-95% |
| Fibers | PE | 5-30% |
| | Tackifying Resin | 0-40% |
| Personal Hygiene Films and | Polymer | 45-95% |
| Fibers | PS | 5-50% |
| | Oil | 0-30% |
| Injection Molded articles | Polymer | 25-100% |
| | Polyolefin | 0-50% |
| | PS | 0-50% |
| | Oil | 0-50% |
| Polymer Modification | Polymer | 5-95% |
| | ABS, PS, HIPS, Cyclic | 95-5% |
| | olefin copolymers | |

### Preparation of the Composition

No particular limitation is imposed on the preparation process of the compositions according to the present invention for the manufacture of films.

Therefore, there may be used any process such as a mechanically mixing process making use of rolls, a Banbury mixer or a Dalton kneader, or twin-screw extruder, thereby obtaining an intimate solution of the composition aimed at.

### Use of the Composition

The composition according to the present invention is used for the manufacture of transparent, gel-free and preferably water-white, cast extruded or extrusion blown films, the combination of mechanical of which and the viscosity of the composition under processing conditions, has been found to be very attractive.

More in particular the composition shows an improved balance of properties of films in personal hygiene applications, i.e. a more stable melt viscosity and providing softer transparent water-white mono- or multi-layer films showing lower tensile strength, low modulus, lower set and no fines/fish eyes/gels.

The present invention will hereinafter be described more specifically by reference to the following examples and comparative examples, however without restricting its scope to these specific embodiments.

Incidentally, all designations of “parts” and “%” as will be used in the following examples mean parts by weight and wt % unless expressly noted otherwise.

### EXAMPLES

The following examples are provided to illustrate the present invention. The examples are not intended to limit the scope of the present invention and they should not be so interpreted. Amounts are in weight parts or weight percentages unless otherwise indicated. Comparisons are also made against commercial block copolymers—Kraton® 1102 (a styrene-butadiene block copolymer) and Kraton® 1164 (a styrene-isoprene block copolymer)

Test Methods
Melt flow rate (MFR): ASTM D 1238-95 (200° C., 5 kg)
Tensile properties according to ASTM D412 (tested on films)
Hysteresis: films are elongated to 80% extension at a speed of 100 mm/sec (load step) held for 30 sec. and then relaxed to zero force (unload step. A second cycle follows right after the first one. Hysteresis is measured as the difference in energy between the load and unload step. Permanent set is measured as the difference between the original sample length of the first cycle (force equals zero) and the sample length before the second cycle (force equals zero).

### Example A

A coupled styrenic block copolymer with a mixed Bd/Ip rubber block was prepared in such a process as to insure the presence of a pure isoprene segment between the styrene and copolymer blocks. Anionic polymerization of styrene (12 kg) in cyclohexane solvent (51 kg) was initiated by addition of s-BuLi (styrene/s-BuLi=12 (kg/mol)). When the styrene had been consumed, an aliquot of the living polymer solution was quenched and analyzed by Gel Permeation Chromatography, GPC; the molecular weight of the styrene block so prepared was 12.2 kg/mol. About 47 kg of this solution was transferred to a second reactor containing 236 kg cyclohexane, and 10.5 kg isoprene. Prior to the transfer, the solution had been titrated with s-BuLi to remove impurities. After the isoprene polymerization had been allowed to proceed for about 1 half-life, 10.5 Kg of butadiene were added at a rate of about 0.4 kg/min; the reaction temperature was maintained at about 60° C.-70° C. When the copolymerization was complete, an aliquot of the living polymer solution was quenched and analyzed by Gel Permeation Chromatography (GPC) and proton NMR, (H-NMR). Basis NMR, the resulting diblock was comprised of about 31% wt styrene and about 53% wt of the diene block was comprised of isoprene. The microstructure was typical for diene polymerizationed in cyclohexane; about 9% of the Bd units were in the 1,2 configuration and about 6% of the isoprene units were in the 3,4 configuration. The molecular weight of the styrene-isoprene/butadine diblock so prepared was about 37.0 kg/mol. A sample was also collected just prior to the start of butadiene addition. As expected, this sample was comprised solely of styrene and isoprene. The molecular weight of the isoprene segment produced at this point was about 11.8 kg/mole. Coupling was affected by adding about 70 grams of tetraethoxysilane. Analysis of the terminated polymer solution by GPC indicated that about 95% of the living diblock chains had coupled, of these about 85% were linear, with the remainder being primarily 3-arm radial polymer. The polymer solution was neutralized by the addition of CO₂ and water, antioxidants (16 g. Irganox 565 and 32 g Irgaphos 168) were added, and the polymer was recovered by hot water coagulation. The polymer had a melt flow of 19.7 g/10 minutes as measured at 200° C. under a load of 5 kg in accordance with ASTM D1238-95. A solution cast film had a tensile strength of 2800 psi.

### Example B

A coupled styrenic block copolymer with a mixed Bd/Ip rubber block was prepared in such a process as to insure that the copolymer segment is richer in isoprene in the region near the styrene endblocks. Anionic polymerization of styrene (21 kg) in cyclohexane solvent (280 kg) was initiated by addition of s-BuLi (styrene/s-BuLi=12 (kg/mol)). When the styrene had been consumed, an aliquot of the living polymer solution was quenched and analyzed by Gel Permeation Chromatography, GPC; the molecular weight of the styrene block so prepared was 12.4 kg/mol. 24.5 kg each of isoprene and butadiene were added at rates of 1.6 kg/min and 0.54 kg/min, respectively. When the copolymerization was complete, an aliquot of the living polymer solution was quenched and analyzed by Gel Permeation Chromatography (GPC) and proton NMR, (H-NMR). Basis NMR, the resulting diblock was comprised of about 29% wt styrene and about 47% wt of the diene block was comprised of isoprene. The microstructure was typical for diene polymerizationed in cyclohexane; about 9% of the Bd units were in the 1,2 configuration and about 6% of the isoprene units were in the 3,4 configuration. The molecular weight of the styrene-isoprene/butadine diblock so prepared was about 43.0 kg/mol. As expected, the rubber segment prepared early in the copolymerization was richer in isoprene. Thus, the polymer has a block that is primarily isoprene, followed by a random I/B block and then a segment comprised primarily of butadiene. The diene block of a sample collected 15 minutes after the start of diene addition was comprised of 64% wt isoprene. In-situ FTIR data obtained over the course of the polymerization indicated that the majority of the isoprene had been consumed while about a third of the butadiene remained to be added. Coupling was affected by adding about 115 grams of methyltrimethoxysilane. Analysis of the terminated polymer solution by GPC indicated that about 94% of the living diblock chains had coupled, of these about 97% were linear, with the remainder being primarily 3-arm radial polymer. The polymer solution was neutralized by the addition of CO₂ and water, antioxidants (84 g. Irganox 565 and 168 g Irgaphos 168) were added, and the polymer was recovered by hot water coagulation.

### Comparative Example A

A sequential styrenic block copolymer with a mixed Bd/Ip rubber block was prepared as described below. Anionic polymerization of styrene (15 kg) in cyclohexane solvent (60 kg) was initiated by addition of s-BuLi (styrene/s-BuLi=11 (kg/mol)). When the styrene had been consumed, an aliquot of the living polymer solution was quenched and analyzed by Gel Permeation Chromatography, GPC; the molecular weight of the styrene block so prepared was 11.0 kg/mol. 64 kg of the above solution was transferred into a second reactor containing 290 kg cyclohexane, and 14.9 kg each of butadiene and isoprene; the contents were titrated with s-butyllithium to remove impurities. The reactor was maintained at a temperature of about 70° C., and 14.9 kg each of isoprene and butadiene were added at a rate of 0.5 kg/min. When the copolymerization was complete, an aliquot of the living polymer solution was quenched and analyzed by Gel Permeation Chromatography (GPC) and proton NMR, (H-NMR). Basis NMR, the resulting diblock was comprised of about 19% wt styrene and about 52% wt of the diene block was comprised of isoprene. The microstructure was typical for diene polymerizationed in cyclohexane; about 9% of the Bd units were in the 1,2 configuration and about 6% of the isoprene units were in the 3,4 configuration. The molecular weight of the styrene-isoprene/butadine diblock so prepared was about 55.8 kg/mol. An additional 12 kg of styrene was added. Basis NMR, the resulting triblock was comprised of about 31% wt styrene and about 50% wt of the diene block was comprised of isoprene. Analysis of the terminated polymer solution by GPC indicated a triblock molecular weight of about 69.0 kg/mole; no diblock peak was discernable in the chromatogram. The solution was neutralized, antioxidant was added, and the polymer was recovered as described above. The polymer had a melt flow of 14.3 g/10 minutes as measured at 200° C. under a load of 5 kg in accordance with ASTM D1238-95

### Comparative Example B

A coupled styrenic block copolymer with a mixed Bd/Ip rubber block was prepared as described below: Anionic polymerization of styrene (24 kg) in cyclohexane solvent (96 kg) was initiated by addition of s-BuLi (styrene/s-BuLi=11 (kg/mol)). When the styrene had been consumed, an aliquot of the living polymer solution was quenched and analyzed by Gel Permeation Chromatography, GPC; the molecular weight of the styrene block so prepared was 11.3 kg/mol. 96 kg of the above solution was transferred into a second reactor containing 170 kg cyclohexane, and 10.5 kg each of butadiene and isoprene; the contents were titrated with s-butyllithium to remove impurities. The reactor was maintained at a temperature of about 60° C., and 10.5 kg each of isoprene and butadiene were added at a rate of 0.5 kg/min. When the copolymerization was complete, an aliquot of the living polymer solution was quenched and analyzed by Gel Permeation Chromatography (GPC) and proton NMR, (H-NMR). Basis NMR, the resulting diblock was comprised of about 32% wt styrene and about 51% wt of the diene block was comprised of isoprene. The microstructure was typical for diene polymerizationed in cyclohexane; about 9% of the Bd units were in the 1,2 configuration and about 6% of the isoprene units were in the 3,4 configuration. The molecular weight of the styrene-isoprene/butadine diblock so prepared was about 36.4 kg/mol. Coupling was affected by adding about 163 grams of tetraethoxysilane. Analysis of the terminated polymer solution by GPC indicated that about 93% of the living diblock chains had coupled, of these about 93% were linear, with the remainder being primarily 3-arm radial polymer. The solution was neutralized, antioxidant was added, and the polymer was recovered as described above. The polymer had a melt flow of 19 g/10 minutes as measured at 200° C. under a load of 5 kg in accordance with ASTM D1238-95

### Comparative Example C

A coupled styrenic block copolymer with a mixed Bd/Ip rubber block was prepared as described below. Anionic polymerization of styrene (21 kg) in cyclohexane solvent (281 kg) was initiated by addition of s-BuLi (styrene/s-BuLi=12 (kg/mol)). When the styrene had been consumed, an aliquot of the living polymer solution was quenched and analyzed by Gel Permeation Chromatography, GPC; the molecular weight of the styrene block so prepared was 12.2 kg/mol. 24.5 kg each of isoprene and butadiene were added at the same rate (about 0.54 kg/min), while the reactor was maintained at a temperature of about 75° C. When the copolymerization was complete, an aliquot of the living polymer solution was quenched and analyzed by Gel Permeation Chromatography (GPC) and proton NMR, (H-NMR). Basis NMR, the resulting diblock was comprised of about 29% wt styrene and about 47% wt of the diene block was comprised of isoprene. The microstructure was typical for diene polymerizationed in cyclohexane; about 9% of the Bd units were in the 1,2 configuration and about 6% of the isoprene units were in the 3,4 configuration. The molecular weight of the styrene-isoprene/butadine diblock so prepared was about 47.0 kg/mol. As expected, the rubber segment prepared early in the copolymerization was richer in isoprene. Coupling was affected by adding about 114 grams of methyltrimethoxysilane. Analysis of the terminated polymer solution by GPC indicated that about 75% of the living diblock chains had coupled, of these about 96% were linear, with the remainder being primarily 3-arm radial polymer. The solution was neutralized, antioxidant was added, and the polymer was recovered as described above.

Table 1 below shows the design information related to each of the Examples. Table 2 shows the neat polymer property data (tensile), while Table 3 shows the neat polymer data (hysteresis). Examples A and B have superior tensile strength to the comparative examples and is comparable to the sequential SIS polymer of example E.

Also shown below is Table 2, which shows the thermal stability as measured by parallel plate rheology (60 minutes in air at 200° C.), the increase in viscosity after one hour for Example A is much less than the comparative examples.

Table 4 below shows the thermal stability in air for one hour at 200° C. This is shown as the change in melt viscosity as a function of aging in air. 100% would signify a doubling in the viscosity. As shown, the SBS block copolymer suffers from crosslinking, and an increase in viscosity, while the SIS block copolymer suffers from chain scission and a loss in viscosity. The polymers according to the invention have the best balance of thermal stability and mechanical performance, as reflected in tensile strength, permanent set and hysteresis properties.

TABLE 1

| | Polymer | PSC, | I/B wt ratio | Coupling |
|---|---|---|---|---|
| Polymer No. | Structure | wt % | in B block | Efficiency, % |
| Inventive | [S—I—(I/B)]ₙX | 31 | 47/53 | 95 |
| Ex. A | | | | |
| Inventive | [S—I—(I/B)]ₙX | 29 | 46/54 | 94 |
| Ex. B | | | | |
| Comp. Ex. A | S—(I/B)—S | 31 | 52/48 | N.A. |
| Comp. Ex. B | [S—(I/B)ₙ]X | 32 | 49/51 | 93 |
| Comp. Ex. C | [S—(I/B)ₙ]X | 28 | 44/56 | 75 |
| Comp. Ex. D | S—I—S | 30 | N.A. | N.A. |
| Kraton ® 1164 | | | | |

TABLE 2

| | Tensile | | Elongation | | 100% mod | | 300% mod | |
|---|---|---|---|---|---|---|---|---|
| | (psi) | | (%) | | (psi) | | (psi) | |
| Polymer No. | Cross | Machine | Cross | Machine | Cross | Machine | Cross | Machine |
| Inventive Ex. A | 3445 | 2455 | 1356 | 1197 | 178 | 220 | 286 | 369 |
| Inventive Ex. B | 3390 | 2814 | 1519 | 1219 | 202 | 317 | 293 | 489 |
| Comp. Ex. A | 1718 | 1644 | 1063 | 1034 | 213 | 231 | 319 | 362 |
| Comp. Ex. B | 2626 | 1969 | 1132 | 1045 | 173 | 220 | 286 | 369 |
| Comp. Ex. C | 1946 | 1698 | 1635 | 1331 | 126 | 279 | 188 | 406 |
| Comp. Ex. D | 3567 | 3028 | 1365 | 1249 | 134 | 331 | 212 | 486 |

TABLE 3

| | Max stress | | Perm. Set | | 50% Stress | |
|---|---|---|---|---|---|---|
| | (psi) | | (%) | | (cyc2 return) | |
| Polymer No. | Cross | Machine | Cross | Machine | Cross | Machine |
| Inventive | 196 | 266 | 17 | 15 | 76 | 116 |
| Ex. A | | | | | | |
| Inventive Ex. B | 185 | 308 | 11 | 26 | 92 | 102 |
| Comp. Ex. A | 185 | 235 | 20 | 18 | 66 | 97 |
| Comp. Ex. B | 212 | 230 | 19 | 17 | 81 | 98 |
| Comp. Ex. C | 143 | 255 | 12 | 21 | 69 | 87 |
| Comp. Ex. D | 133 | 275 | 8.4 | 13 | 71 | 110 |

TABLE 4

| | | Change of | |
|---|---|---|---|
| | Polymer | Viscosity after 1 | |
| Polymer No. | Structure | hour at 230° C. | Comments |
| Kraton ® 1102 | (S—B)₂X | 519% | Crosslinking |
| Kraton ® 1164 | S—I—S | −2.7% | Chain scission |
| Inventive Ex. A | [S—I—(I/B)]ₙX | 31% | |
| Inventive Ex. B | [S—I—(I/B)]ₙX | 62% | |
| Comp. Ex. C | [S—(I/B)ₙ]X | 73% | |

What is claimed is:

1. A block copolymer of the formula:
[S-I-(I/B)]ₙX or [S-I-(I/B)-B]ₙX or mixtures thereof,
wherein each S is independently a polymer block of an alkenyl arene having a molecular weight of 8,000 to 25,000,
each I is a polymer block of isoprene having a molecular weight of 5,000 to 10,000,
each (I/B) is a mixed random polymer block of isoprene and butadiene in a weight ratio of isoprene to butadiene of from about 10:90 to about 90:10,
n is an integer equal to or greater than 2,
each B is a polymer block of butadiene having a molecular weight of 1,000 to 50,000,
X is the residue of a coupling agent, where the block copolymer has a coupling efficiency of greater than 90 weight percent, and
wherein the alkenyl arene content of the block copolymer represents a weight ratio of the alkenyl arene block to conjugated diene block of the total block copolymer and is in the range of from about 10 to about 35 wt %.

2. The block copolymer of claim 1 wherein each S block has an apparent molecular weight from about 10,000 to about 18,000.

3. The block copolymer of claim 1 wherein each I block has an apparent molecular weight from about 6,000 to about 8,000.

4. The block copolymer of claim 1 wherein each B block has an apparent molecular weight of from about 1,000 to about 15,000.

5. The block copolymer of claim 1 wherein each I/B block has an apparent molecular weight of about 25,000 to about 150,000.

6. The block copolymer of claim 1 wherein the apparent molecular weight of the block copolymer is from about 40,000 to about 400,000.

7. The block copolymer of claim 1 wherein the apparent molecular weight of the block copolymer is from about 70,000 to about 150,000.

8. The block copolymer of claim 1 wherein the block copolymer has a coupling efficiency greater than 93%.

9. The block copolymer of claim 1 wherein the 1,2-vinyl bonds for the butadiene portion and the 3,4-vinyl bonds for the isoprene portion are in a proportion of at most 15 wt %, based on the total weight of the conjugated diene.

10. A composition to be used for the manufacture of transparent, gel-free films, comprising:
a) at least 30 wt % of a styrenic block copolymer of the formula
[S-I-(I/B)]ₙX or [S-I-(I/B)-B]ₙX or mixtures thereof,
wherein each S is independently a polymer block of an alkenyl arene having a molecular weight of 8,000 to 25,000,
each I is a polymer block of isoprene having a molecular weight of 5,000 to 10,000,
each (I/B) is a mixed random polymer block of isoprene and butadiene in a weight ratio of isoprene to butadiene of from about 10:90 to about 90:10,
n is an integer equal to or greater than 2,
each B is a polymer block of butadiene having a molecular weight of 1,000 to 50,000,
X is the residue of a coupling agent, where the block copolymer has a coupling efficiency of greater than 90 weight percent, and
wherein the alkenyl arene content of the block copolymer represents a weight ratio of the alkenyl arene block to conjugated diene block of the total block copolymer and is in the range of from about 10 to about 35 wt %.
b) from 5 to 70 wt % of one or more components selected from the group consisting of olefin polymers, styrene polymers, styrene/diene block copolymers, hydrogenated styrene/diene block copolymers, tackifying resins, and end block resins, and
c) from 0 to 10 wt % of a plasticizing oil.

11. A composition according to claim 10, wherein the component b) is an olefin polymer selected from the group consisting of ethylene homopolymers, ethylene/alpha-olefin copolymers, propylene homopolymers, propylene/alpha-olefin copolymers, high impact polypropylene, butylene homopolymers and butylene/alpha olefin copolymers.

12. A composition according to claim 10 wherein the component b) is a styrene polymer selected from the group consisting of crystal polystyrene, high impact polystyrene, medium impact polystyrene, styrene/acrylonitrile copolymers, styrene/acrylonitrile/butadiene (ABS) polymers, syndiotactic polystyrene, styrene/methyl-methacrylate copolymers and styrene/olefin copolymers or a block copolymer selected from the group consisting of styrene/diene block copolymers, hydrogenated styrene/diene block copolymers, and mixtures thereof.

13. A composition according to claim 10, wherein each S block has an apparent molecular weight from about 10,000 to about 18,000.

14. A composition according to claim 10, wherein each I block has an apparent molecular weight from about 6,000 to about 8,000.

15. A composition according to claim 10, wherein the apparent molecular weight of the block copolymer is from about 40,000 to about 400,000.

16. A composition according to claim 10, wherein the block copolymer has a coupling efficiency greater than 93%.

17. A composition according to claim 10, wherein the 1,2-vinyl bonds for the butadiene portion and the 3,4-vinyl bonds for the isoprene portion are in a proportion of at most 15 wt %, based on the total weight of the conjugated diene.

18. Extruded mono- or multi-layer films prepared from the compositions according to claim 10.

19. Cast or blown mono- or multi-layer films for personal hygiene applications, prepared from the compositions according to claim 10.

20. The block copolymer of claim 10 having a melt flow of 1 to about 40 g/10 minutes as measured at 200° C. under a load of 5 kg in accordance with ASTM D1238; tensile strength of at least about 2700 psi as measured according to ASTM D412, and thermal stability of less than about 100% increase in viscosity after one hour at 230° C.
